(19) United States
(12) Patent Application Publication
(10) Pub. No.: US 2020/0070684 A1
(43) Pub. Date: Mar. 5, 2020

(54) CAPACITY ESTIMATION SYSTEM, CAPACITY ESTIMATION METHOD, AND PROGRAM

(71) Applicant: HONDA MOTOR CO., LTD., Tokyo (JP)

(72) Inventor: Naoki Maruno, Wako-shi (JP)

(21) Appl. No.: 16/543,730

(22) Filed: Aug. 19, 2019

(30) Foreign Application Priority Data
Sep. 3, 2018 (JP) 2018-164912

(51) Int. Cl. B60L 58/18; B60L 58/12; G07C 5/00

(52) U.S. Cl. CPC B60L 58/18; G07C 5/008; B60L 58/12

(57) ABSTRACT

A capacity estimation system includes an acquisition unit configured to acquire, for each of a plurality of vehicles, transition information which is information indicating a transition of a battery capacity of a secondary battery of the vehicle and usage history information which is information indicating a usage history of the secondary battery, a database generation unit configured to generate a database including the transition information and the usage history information for each of the plurality of vehicles, a selection unit configured to select at least transition information among transition information and usage history information of a vehicle which are similar to transition information and usage history information of a target vehicle among the plurality of vehicles, and an estimation unit configured to estimate a battery capacity of a secondary battery of the target vehicle on the basis of at least the transition information selected by the selection unit.

### CROSS-REFERENCE TO RELATED APPLICATION

Priority is claimed on Japanese Patent Application No. 2018-164912, filed Sep. 3, 2018, the content of which is incorporated herein by reference.

### BACKGROUND OF THE INVENTION

### Field of the Invention

The present invention relates to a capacity estimation system, a capacity estimation method, and a program.

### Description of Related Art

There are an electric vehicle in which a travel motor is mounted and a hybrid vehicle in which a travel motor and an engine are mounted. The travel motor is driven by power supplied from a secondary battery.

To allow the vehicle to travel all the way to a destination point from a departure point, the charge amount of the secondary battery needs to be accurately estimated. Thus, there is a technology in which an information center estimates the charge amount of a secondary battery mounted in a vehicle (see Japanese Patent No. 5454537).

### SUMMARY OF THE INVENTION

To accurately estimate the charge amount of a secondary battery of a vehicle, first, a control device mounted in the vehicle needs to accurately estimate the battery capacity of the secondary battery. The control device of the related art determines the battery capacity of the secondary battery of the vehicle on the basis of the amount of change (ΔAh) of the current integration value per the amount of change (ΔSOC) of the charge rate (state of charge (SOC)) of the secondary battery.

However, when the secondary battery is charged every time the vehicle travels a short distance, the amount of change (ΔAh) of the current integration value of the secondary battery may be small. In such a case, the capacity estimation device of the related art cannot improve the estimation accuracy of the battery capacity of the secondary battery.

Aspects regarding the present invention have been made in view of the above circumstances and it is an object thereof to provide a capacity estimation system, a capacity estimation method, and a program which can improve the estimation accuracy of the battery capacity of the secondary battery.

To solve the above problem and achieve the relevant object, the present invention adopts the following aspects.

(1) A capacity estimation system according to an aspect of the present invention includes an acquisition unit configured to acquire, for each of a plurality of vehicles, transition information which is information indicating a transition of a battery capacity of a secondary battery of the vehicle and usage history information which is information indicating a usage history of the secondary battery, a database generation unit configured to generate a database including the transition information and the usage history information for each of the plurality of vehicles, a selection unit configured to select at least transition information among transition information and usage history information of a vehicle which are similar to transition information and usage history information of a target vehicle among the plurality of vehicles, and an estimation unit configured to estimate a battery capacity of a secondary battery of the target vehicle on the basis of the at least transition information selected by the selection unit.

(2) In the above aspect (1), the acquisition unit, the database generation unit, and the selection unit may be realized by a vehicle exterior device, and at least part of the estimation unit may be realized by a device mounted in the target vehicle.

(3) In the above aspect (2), the device mounted in the target vehicle may be configured to transmit a request signal to the selection unit when a state in which an estimated value of the battery capacity of the secondary battery is not updated has continued over a reference or more, and the selection unit may be configured to transmit data for estimation of the battery capacity of the secondary battery in response to the request signal from the target vehicle.

(4) In any one of the above aspects (1) to (3), the selection unit may be configured to select at least transition information among transition information and usage history information of a vehicle in which a secondary battery whose elapsed usage time is longer than an elapsed usage time of the secondary battery of the target vehicle is mounted or a vehicle that has traveled a travel distance longer than a travel distance of the target vehicle.

(5) In any one of the above aspects (1) to (4), the usage history of the secondary battery may be a history of at least one of a charge rate, a current value, a voltage value, and a temperature of the secondary battery.

(6) A capacity estimation method according to an aspect of the present invention includes: acquiring, by one or more computers, for each of a plurality of vehicles, transition information which is information indicating a transition of a battery capacity of a secondary battery of the vehicle and usage history information which is information indicating a usage history of the secondary battery; generating, by the one or more computers, a database including the transition information and the usage history information for each of the plurality of vehicles; selecting, by the one or more computers, at least transition information among transition information and usage history information of a vehicle which are similar to transition information and usage history information of a target vehicle among the plurality of vehicles; and estimating, by the one or more computers, a battery capacity of a secondary battery of the target vehicle on the basis of the selected at least transition information.

(7) A computer readable non-transitory storage medium according to an aspect of the present invention includes stores a program for causing one or more computers to execute acquiring, for each of a plurality of vehicles, transition information which is information indicating a transition of a battery capacity of a secondary battery of the vehicle and usage history information which is information indicating a usage history of the secondary battery, generating a database including the transition information and the usage history information for each of the plurality of vehicles, selecting at least transition information among transition information and usage history information of a vehicle which are similar to transition information and usage history information of a target vehicle among the plurality of vehicles, and estimating a battery capacity of a secondary battery of the target vehicle on the basis of the selected at least transition information.

According to the above aspects (1) to (7), it is possible to improve the estimation accuracy of the battery capacity of the secondary battery.

### BRIEF DESCRIPTION OF THE DRAWINGS

FIG. 1 is a diagram showing an exemplary configuration of a capacity estimation system.

FIG. 2 is a diagram showing an exemplary configuration of a vehicle.

FIG. 3 is a diagram showing an example of a display unit.

FIG. 4 is a diagram showing an example of transition information of the battery capacity of a battery of each vehicle other than a target vehicle.

FIG. 5 is a diagram showing an example of usage history information of the battery of each vehicle other than the target vehicle.

FIG. 6 is a diagram showing an example of transition information of the battery capacity of the battery of the target vehicle.

FIG. 7 is a diagram showing an example of usage history information of the battery of the target vehicle.

FIG. 8 is a diagram showing an example of transition information of the battery capacity of the battery of each vehicle including the target vehicle.

FIG. 9 is a diagram showing an example of usage history information of the battery of each vehicle including the target vehicle.

FIG. 10 is a sequence diagram showing an exemplary operation of the target vehicle.

FIG. 11 is a sequence diagram showing an exemplary operation of the capacity estimation system.

FIG. 12 is a diagram showing an exemplary configuration of the capacity estimation system.

FIG. 13 is a sequence diagram showing an exemplary operation of the capacity estimation system.

### DETAILED DESCRIPTION OF THE INVENTION

Hereinafter, embodiments of a capacity estimation system, a capacity estimation method, and a program according to the present invention will be described with reference to the drawings.

### First Embodiment

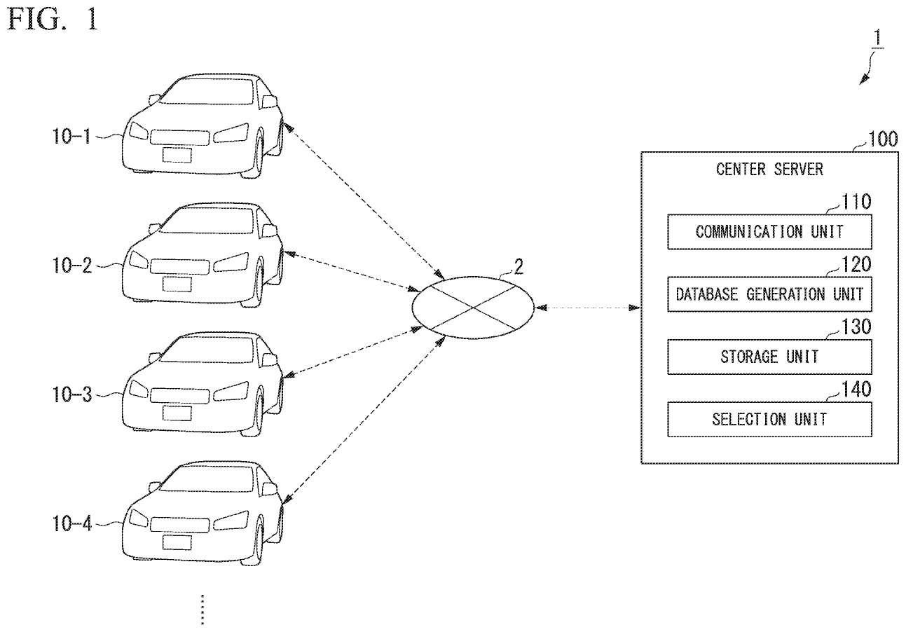

FIG. 1 is a diagram showing an exemplary configuration of a capacity estimation system 1. The capacity estimation system 1 is a system for estimating the battery capacity of a battery (secondary battery) mounted in a vehicle. The battery capacity decreases with deterioration of the battery. Thus, the battery capacity is an index indicating the degree of deterioration of the battery. For example, the degree of deterioration is the rate of decrease of the battery capacity from the initial value.

For example, when the battery capacity has decreased by 10% from the initial value “100” to “90,” the degree of deterioration is 10%.

The capacity estimation system 1 includes a plurality of vehicles 10 and a center server 100 (an example of the vehicle exterior device). A communication line 2 is a line including a wireless base station or the like, and is, for example, the Internet, a wide area network (WAN), or a local area network (LAN). The communication line 2 may include a cellular network, a Wi-Fi network, and a wired line.

Each vehicle 10 is an electric vehicle or a hybrid vehicle. Each vehicle 10 communicates with the center server 100 via the communication line 2. Each vehicle 10 transmits information indicating a transition of the battery capacity of the battery of the vehicle (hereinafter referred to as “transition information”) and information indicating a usage history of the battery of the vehicle (hereinafter referred to as “usage history information”) to the center server 100 at a predetermined time.

The predetermined time is not limited to a specific time and examples thereof include a time when the load of the battery of the vehicle 10 has exceeded a certain amount, a time based on an instruction from the user of the vehicle 10, a time every predetermined short period (for example, every hour) or every predetermined long period (for example, every month), a time when the vehicle has traveled all the way to the destination from the departure point, a time when the battery is activated, a time when the center server 100 has requested that various information such as transition information and usage history information of the battery be transmitted, and a time when the amount of an increase in the load of the battery of the vehicle 10 from the transmission time of various previous information has reached a certain amount.

Each vehicle 10 updates an estimated value of the battery capacity of the battery of the vehicle when the amount of change of “the amount of change of the charge rate of the secondary battery (ΔSOC)/the amount of change of the current integration value (ΔAh)” is equal to or greater than a threshold (when data for estimation of the battery capacity has been sufficiently obtained). On the other hand, each vehicle 10 transmits a signal requesting data for estimation of the battery capacity of the battery of the vehicle (hereinafter referred to as a “request signal”) to the center server 100 when a state in which the estimated value of the battery capacity is not updated has continued over a reference or more since data for estimation of the battery capacity has not been sufficiently obtained. The term “over a reference or more” means, for example, that a period during which it is not updated is 10 days or more or that the travel distance of the vehicle in a state in which it is not updated is 150 km or more. The vehicle 10 acquires data for estimation of the battery capacity of the battery of the vehicle from the center server 100.

The vehicle 10 predicts a measurement result of the battery capacity of the battery of the vehicle on the basis of the data for estimation acquired from the center server 100 or corrects the estimation result thereof on the basis of the same. Thus, the vehicle 10 can improve the estimation accuracy of the battery capacity (the degree of deterioration) of the battery of the vehicle.

In the following, a vehicle in which a battery whose battery capacity is to be estimated is mounted (hereinafter referred to as a “target vehicle”) is vehicle 10-1 as an example.

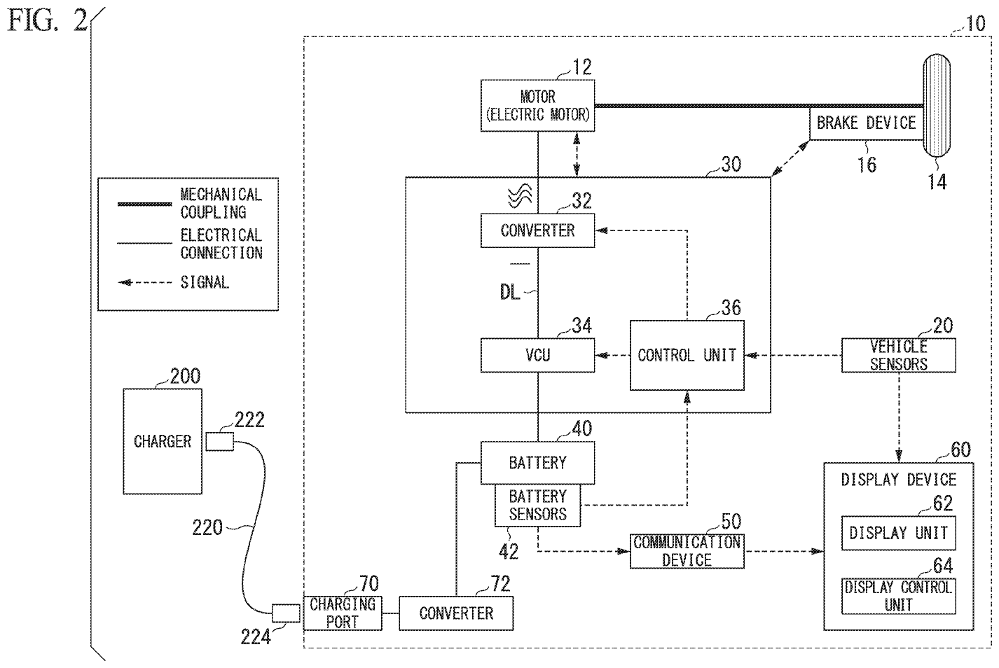

FIG. 2 is a diagram showing an exemplary configuration of the vehicle 10. The vehicle 10 includes a motor 12, drive wheels 14, a brake device 16, vehicle sensors 20, a power control unit (PCU) 30, a battery 40, battery sensors 42, a communication device 50, a display device 60, a charging port 70, and a converter 72.

The motor 12 is, for example, a three-phase alternating current motor. A rotor of the motor 12 is coupled to the drive wheels 14. The motor 12 outputs power to the drive wheels 14 using supplied power. The motor 12 generates electric power using kinetic energy of the vehicle when the vehicle decelerates. The drive wheels 14 are driven according to driving force of the motor 12.

The brake device 16 is a hydraulic brake device. The brake device 16 operates under the control of the PCU 30. The brake device 16 includes an electric motor, a cylinder, and a brake caliper. The electric motor generates a hydraulic pressure in the cylinder. The cylinder transmits the generated hydraulic pressure to the brake caliper. The brake caliper presses brake pads against the brake rotor according to the hydraulic pressure. The brake device 16 may have a mechanism for transferring a hydraulic pressure generated by an operation of a brake pedal to the cylinder as a backup mechanism.

The vehicle sensors 20 include an accelerator opening degree sensor, a vehicle speed sensor, and a brake depression amount sensor. The accelerator opening degree sensor is attached to an accelerator pedal. The accelerator pedal is an operating element that receives an acceleration instruction from the driver. The accelerator opening degree sensor detects the amount of operation of the accelerator pedal and outputs the detection result to a control unit 36 as the accelerator opening degree.

The vehicle speed sensor includes wheel speed sensors and a speed calculator. The wheel speed sensors are attached to the wheels. The vehicle speed sensor combines wheel speeds detected by the wheel speed sensors and derives the speed of the vehicle (vehicle speed) on the basis of the combination result. The vehicle speed sensor outputs information representing the speed of the vehicle to the control unit 36 and the display device 60. The brake depression amount sensor is attached to the brake pedal. The brake depression amount sensor detects the amount of operation of the brake pedal and outputs the detection result to the control unit 36 as information representing the brake depression amount.

The PCU 30 includes a converter 32, a voltage control unit (VCU) 34, and the control unit 36. The converter 32, the VCU 34 and the control unit 36 may be disposed in a distributed manner.

The converter 32 is a device that converts an AC voltage into a DC voltage. A DC terminal of the converter 32 is connected to the VCU 34 via a DC link DL. The VCU 34 is connected to the battery 40. The converter 32 converts an AC voltage generated by the motor 12 into a DC voltage. The converter 32 outputs the DC voltage, which is the conversion result, to the VCU 34 via the DC link DL.

The VCU 34 is a voltage converter. The VCU 34 boosts a DC voltage supplied from the battery 40. The VCU 34 outputs the boosted DC voltage to the DC terminal of the converter 32 via the DC link DL. The VCU 34 boosts the DC voltage on the DC link DL according to an instruction from the motor control unit.

The control unit 36 includes a motor control unit, a brake control unit, and a battery/VCU control unit. The motor control unit, the brake control unit, and the battery/VCU control unit may be separate control devices (a motor electronic control unit (ECU), a brake ECU, and a battery ECU).

The motor control unit controls driving of the motor 12 via the converter 32 on the basis of outputs of the vehicle sensors 20. The brake control unit controls brake driving of the brake device 16 on the basis of outputs of the vehicle sensors 20.

The battery/VCU control unit derives a state of charge (SOC) of the battery 40 on the basis of outputs of the battery sensors 42. If the amount of change of “the amount of change of the charge rate of the secondary battery (ΔSOC)/the amount of change of the current integration value (ΔAh)” is equal to or greater than a threshold, the battery/VCU control unit derives the battery capacity (the degree of deterioration) of the battery 40 on the basis of the result (=ΔAh/ΔSOC) of dividing the amount of change of the current integration value of the battery 40 by the amount of change of the charge rate of the battery 40.

The battery/VCU control unit transmits a request signal to the center server 100 via the communication device 50 when a state in which an estimated value of the battery capacity is not updated has continued over a preset value or more. The battery/VCU control unit acquires data for estimation of the battery capacity of the battery 40 of the vehicle from the center server 100 as a response to the request signal. The battery/VCU control unit corrects the estimated value of the battery capacity of the battery of the vehicle with the data for estimation acquired from the center server 100.

The battery/VCU control unit generates transition information of the battery 40. The transition information of the battery 40 includes information representing the battery capacity and information representing the elapsed time of use of the battery 40 from the start of use (hereinafter referred to as an “elapsed usage time”). The transition information of the battery 40 may include information representing the travel distance of the vehicle instead of the information representing the elapsed usage time. The transition information of the battery 40 may further include information representing an initial value of the battery capacity (the battery capacity before deterioration).

The battery/VCU control unit generates usage history information of the battery 40 on the basis of the outputs of the battery sensors 42. The usage history information of the battery 40 includes, for example, information of factors affecting the deterioration of the battery 40. The information of factors affecting the deterioration is, for example, distribution information representing the relationship between the SOC (charge rate) and temperature, distribution information representing the relationship between the discharge current and temperature, and distribution information representing the relationship between the charge current and temperature.

The battery/VCU control unit outputs the transition information and usage history information of the battery 40 to the communication device 50 and the display device 60. The battery/VCU control unit also outputs the transition information and usage history information of the battery 40 to the VCU 34 and the communication device 50. The battery/VCU control unit may output the transition information and usage history information of the battery 40 to the display device 60.

The battery 40 is a secondary battery such as a lithium ion battery. The battery 40 stores power supplied from a charger 200 outside the vehicle 10. The battery 40 outputs the stored power to the VCU 34.

The battery sensors 42 are sensors that measure the environment of the battery 40, and are, for example, a voltage sensor, a current sensor, and a temperature sensor. The battery sensors 42 detect the current value, the voltage value, and the temperature of the battery 40. The battery sensors 42 output information representing the detected current value, voltage value, and temperature to the control unit 36. The battery sensors 42 may also output information representing the detected current value, voltage value and temperature to the communication device 50.

The communication device 50 is a device that wirelessly connects to the communication line 2. The communication device 50 communicates with the center server 100 via the communication line 2. The communication device 50 may communicate with the user's communication terminal (for example, a smart phone terminal or a tablet terminal). The user's communication terminal may display an image representing the battery capacity or the charge rate.

The communication device 50 acquires the transition information and usage history information of the battery 40 from the battery/VCU control unit. The communication device 50 transmits the transition information and usage history information of the battery 40 to the center server 100. The communication device 50 also transmits a vehicle number of the vehicle (for example, license plate information, communication identification information of the communication device 50, or identification information assigned to a registered user) to the center server 100. The communication device 50 may also transmit type information of the battery 40 and vehicle type information of the vehicle to the center server 100. The communication device 50 acquires a request signal from the battery/VCU control unit. The communication device 50 transmits a request signal to the center server 100.

The communication device 50 receives information, which has been transmitted from the center server 100 to the vehicle, via the communication line 2. For example, the communication device 50 receives data for estimation of the battery capacity of the battery 40 from the center server 100. The communication device 50 outputs to the control unit 36 and the display device 60 the information that has been transmitted from the center server 100 to the vehicle.

The communication device 50 acquires, from the control unit 36, information representing the charge rate of the battery 40 and information representing the number of days left until the degree of deterioration of the battery 40 exceeds a threshold. The communication device 50 outputs information representing the charge rate of the battery 40 to the display device 60. The communication device 50 may output, to the display device 60, the information representing the number of days left until the degree of deterioration of the battery 40 exceeds the threshold. The communication device 50 acquires, from the battery sensors 42, information representing the current value, the voltage value, and the temperature of the battery 40. The communication device 50 outputs the information representing the current value, the voltage value, and the temperature of the battery 40 to the display device 60.

The display device 60 is a display device such as a liquid crystal display or an organic electroluminescence (EL) display. The display device 60 is provided in the occupant compartment of the vehicle 10. The display device 60 includes a display unit 62 and a display control unit 64. The display unit 62 displays an image under the control of the display control unit 64. The image displayed on the display device 60 may also be displayed on a display unit of the user's communication terminal through the communication device 50.

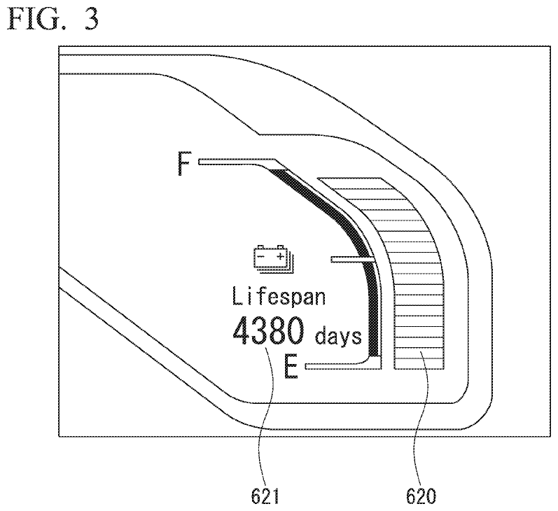

FIG. 3 is a diagram showing an example of the display unit 62. The display unit 62 includes a charge rate display unit 620 and a number-of-days display unit 621. The display control unit 64 causes the charge rate display unit 620 to display an image (for example, a bar graph) representing the charge rate of the battery 40 in accordance with information output from the control unit 36 or the communication device 50. The display control unit 64 causes the number-of-days display unit 621 to display the number of days left until the degree of deterioration of the battery 40 exceeds the threshold according to information output from the control unit 36 or the communication device 50. The battery capacity corresponds to, for example, the charge amount from a mark “E” (EMPTY) to a mark “F” (FULL) shown in FIG. 3.

The display control unit 64 may cause the display unit 62 to display numerical images representing the vehicle speed and the like output from the vehicle sensors 20. The display control unit 64 may also cause the display unit 62 to display numerical images representing the current value, the voltage value, and the temperature of the battery 40.

Returning to FIG. 2, the description of the exemplary configuration of the vehicle 10 will continue. The charging port 70 is connected to the charger 200 via a charging cable 220. The charging cable 220 includes a first plug 222 and a second plug 224. The first plug 222 is connected to the charger 200. The second plug 224 is connected to the charging port 70. Power output from the charger 200 is supplied to the charging port 70 via the charging cable 220.

Each of the first plug 222 and the second plug 224 includes a power connector and a signal connector. The charging cable 220 includes a power cable and a signal cable. The signal cable relays communication between the vehicle 10 and the charger 200.

The converter 72 is provided between the charging port 70 and the battery 40. The converter 72 converts an AC voltage, which has been supplied from the charger 200 to the converter 72 via the charging port 70, into a DC voltage. The converter 72 outputs the converted DC voltage to the battery 40.

Returning to FIG. 1, the description of the exemplary configuration of the capacity estimation system 1 will continue. The center server 100 is a vehicle exterior device that generates data for estimation of the battery capacity (the degree of deterioration) of the battery 40 mounted in the vehicle 10, and is, for example, a server. The center server 100 acquires a vehicle number, transition information, and usage history information from each vehicle 10 via the communication line 2. The center server 100 generates a transition information database for vehicles 10 (a big data database). The center server 100 also generates a usage history information database for vehicles 10 (a big data database).

The center server 100 identifies a target vehicle from among the vehicles 10 on the basis of the acquired vehicle number. Upon acquiring a request signal from the target vehicle, the center server 100 generates data for estimation of the battery capacity of the battery 40 of the target vehicle on the basis of each database. The data for estimation includes, for example, information indicating a weight coefficient and a battery capacity for each vehicle 10. The center server 100 transmits the data for estimation of the battery capacity of the battery 40 to the target vehicle.

The center server 100 includes a communication unit 110 (acquisition unit), a database generation unit 120, a storage unit 130, and a selection unit 140.

The database generation unit 120 and the selection unit 140 are realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA) or a graphics processing unit (GPU), or may be realized by hardware and software in cooperation. The program may be stored in advance in a storage device (non-transitory storage medium) such as a hard disk drive (HDD) or a flash memory, or may be stored in a detachable storage medium (non-transitory storage medium) such as a DVD or a CD-ROM and then installed in the storage device by inserting the storage medium into a drive device. The storage unit 130 is realized by this storage device.

The communication unit 110 acquires transition information and usage history information of the battery 40 and a vehicle number of the vehicle 10 from each vehicle 10. The communication unit 110 may also acquire type information of the battery 40 and vehicle type information of the vehicle 10 from each vehicle 10. The communication unit 110 outputs these various pieces of information to the database generation unit 120.

The database generation unit 120 generates a transition information database for the batteries 40 of vehicles 10 and a usage history information database for the batteries 40 of vehicles 10. The database generation unit 120 records the transition information database and the usage history information database in the storage unit 130.

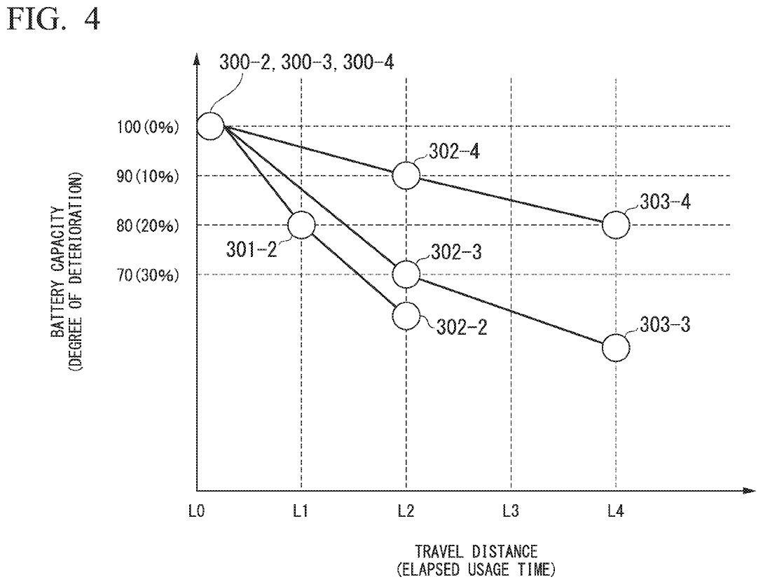

FIG. 4 is a diagram showing an example of the transition information (transition information database) for the battery capacities of the batteries 40 of vehicles 10 other than the target vehicle. The horizontal axis represents the travel distance (travel pattern) of the vehicle 10 or the elapsed usage time of the battery 40. The vertical axis represents the battery capacity or the degree of deterioration of the battery 40 of the vehicle 10. In FIG. 4, the transition information of the battery capacity of the battery 40 of the target vehicle may not yet be recorded in the transition information database for vehicles 10.

A dot 300-n, a dot 301-n, a dot 302-n, and a dot 303-n (where n is a symbol identifying the vehicle 10 and is an integer of 1 or more) represent the transition of the battery capacity of a battery 40 of a vehicle 10-n in that order.

In a vehicle 10-2, the battery capacity is measured on the basis of a short travel distance (for example, a distance of “L1-L0”). Therefore, the estimation accuracy of the battery capacity of the battery 40 of the vehicle 10-2 may be low. In a vehicle 10-3, the battery capacity is measured on the basis of a long travel distance (for example, a distance of “L2-L0”). Therefore, there is a high possibility that the estimation accuracy of the battery capacity of the battery 40 of the vehicle 10-3 is high. In a vehicle 10-4, the battery capacity is measured on the basis of a long travel distance (for example, a distance of “L2-L0”). Therefore, there is a high possibility that the estimation accuracy of the battery capacity of the battery 40 of the vehicle 10-4 is high.

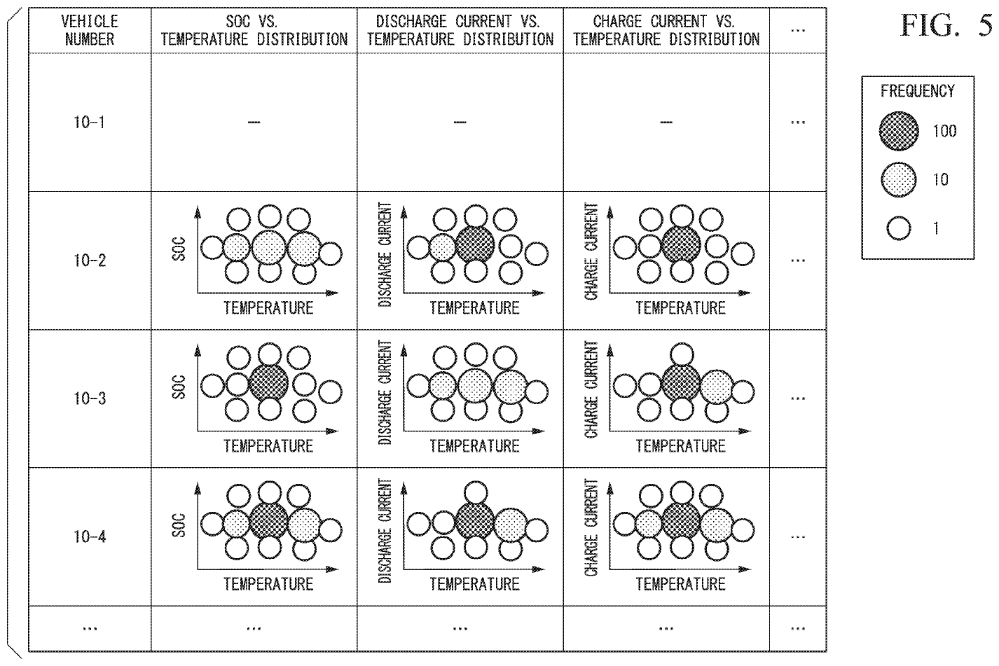

FIG. 5 is a diagram showing an example of the usage history information (usage history information database) for the batteries 40 of vehicles 10 other than the target vehicle. In the usage history information, distribution information representing the relationship between the SOC (charge rate) and temperature, distribution information representing the relationship between the discharge current and temperature, and distribution information representing the relationship between the charge current and temperature are recorded for each vehicle number as information of factors affecting the deterioration of the battery 40. In FIG. 5, the usage history information of the battery 40 of the target vehicle may not yet be recorded in the usage history information database for vehicles 10.

The database generation unit 120 acquires, from the communication unit 110, the transition information of the battery 40 of the target vehicle, the usage history information of the battery 40 of the target vehicle, and the vehicle number “10-1” of the target vehicle.

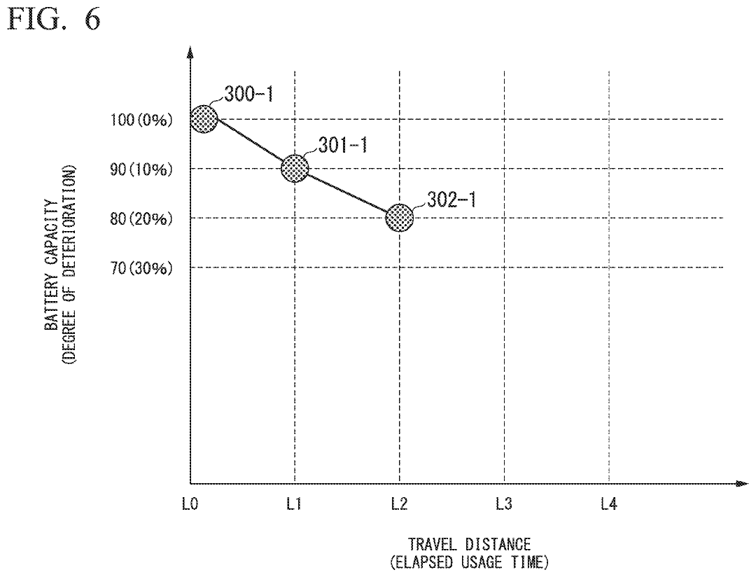

FIG. 6 is a diagram showing the transition information of the battery capacity of the battery 40 of the target vehicle. The horizontal axis represents the travel distance of the target vehicle or the elapsed usage time of the battery 40 of the target vehicle. The vertical axis represents the battery capacity or the degree of deterioration of the battery 40. A dot 300-1, a dot 301-1 and a dot 302-1 represent the transition of the battery capacity of the battery 40 of the vehicle 10-1 in that order. In the vehicle 10-1, the battery capacity is measured on the basis of a short travel distance (for example, a distance of “L1-L0”). Therefore, the estimation accuracy of the battery capacity of the battery 40 of the vehicle 10-1 may be low. The database generation unit 120 records the transition information illustrated in FIG. 6 and the vehicle number of the target vehicle in the transition information database for the batteries 40 of vehicles 10 illustrated in FIG. 4. In FIG. 6, the travel distance of the vehicle 10-1 is L2. The battery capacity of the battery 40 of the vehicle 10-1 is 80. Thus, the degree of deterioration of the battery 40 of the vehicle 10-1 is 20%.

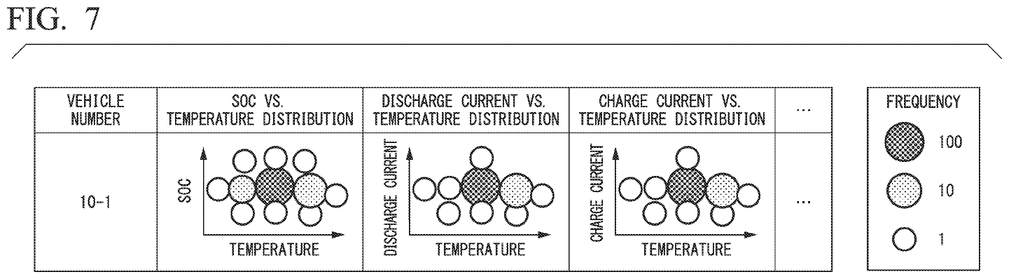

FIG. 7 is a diagram showing an example of the usage history information of the battery 40 of the target vehicle. In the usage history information illustrated in FIG. 7, distribution information representing the relationship between the SOC (charge rate) and temperature of the battery 40 of the target vehicle, distribution information representing the relationship between the discharge current and temperature of the battery 40 of the target vehicle, and distribution information representing the relationship between the charge current of the battery 40 and the temperature of the target vehicle are included as information of factors affecting the deterioration of the battery 40. The database generation unit 120 records the usage history information illustrated in FIG. 7 and the vehicle number of the target vehicle in the usage history information database for the batteries 40 of vehicles 10 illustrated in FIG. 5.

The storage unit 130 stores the transition information database for the batteries 40 of vehicles 10 and the usage history information database for the batteries 40 of vehicles 10. The storage unit 130 may also store a program.

(When Generating Data for Estimation from Selected Transition Information)

The selection unit 140 accesses the storage unit 130 and refers to the transition information database. The selection unit 140 selects one or more vehicles 10 other than the target vehicle from the transition information database on the basis of the transition information acquired from the vehicle 10-1 which is the target vehicle.

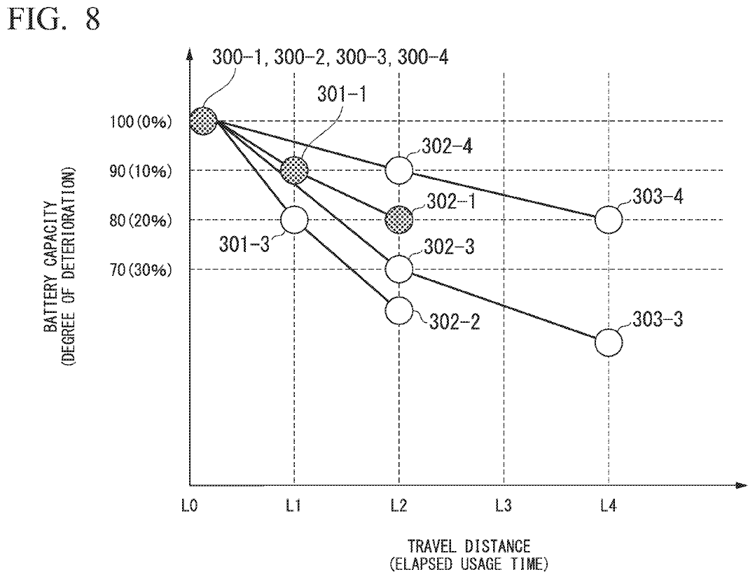

FIG. 8 is a diagram showing an example of the transition information (transition information database) for the battery capacities of the batteries 40 of vehicles 10 including the target vehicle. The horizontal axis represents the travel distance of the vehicle 10 or the elapsed usage time of the battery 40. The vertical axis represents the battery capacity or the degree of deterioration of the battery 40 of the vehicle 10.

The selection unit 140 selects vehicles 10 that have traveled a travel distance longer than the travel distance of “L2” of the target vehicle. The selection unit 140 may also select vehicles 10 in which batteries 40 whose elapsed usage times are longer than the elapsed usage time of the battery 40 of the target vehicle are mounted. In FIG. 8, the selection unit 140 selects the vehicle 10-3 and the vehicle 10-4.

The selection unit 140 selects the transition information of the selected vehicle 10-3 and the transition information of the selected vehicle 10-4 from the transition information database. The selection unit 140 transmits data for estimation including the selected transition information to the vehicle 10-1 via the communication unit 110.

(When Generating Data for Estimation from Selected Transition Information and Usage History Information)

The selection unit 140 selects vehicles 10 in the same manner as the above section “when generating data for estimation from selected transition information.” The selection unit 140 selects the transition information of the selected vehicle 10-3 and the transition information of the selected vehicle 10-4 from the transition information database.

The selection unit 140 further accesses the storage unit 130 and refers to the usage history information database. Based on the usage history information acquired from the vehicle 10-1 which is the target vehicle, the selection unit 140 selects usage history information similar to the usage history information of the target vehicle from the usage history information database.

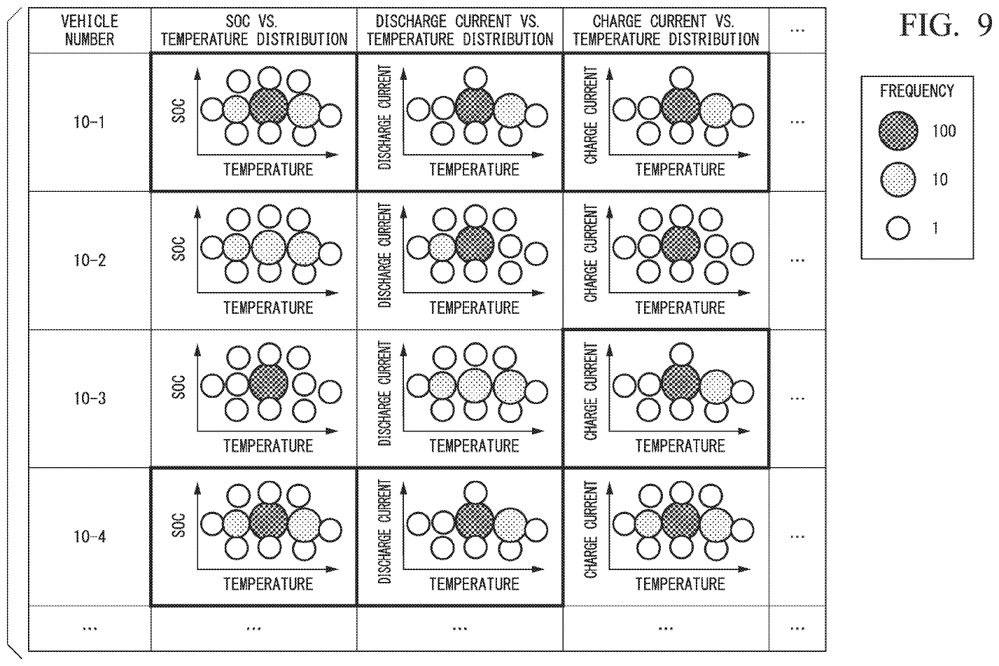

FIG. 9 is a diagram showing an example of the usage history information (usage history information database) for the batteries 40 of vehicles 10 including the target vehicle. The selection unit 140 selects usage history information similar to the usage history information of the target vehicle from the usage history information of each of the selected vehicles 10.

In FIG. 9, the selection unit 140 selects distribution information “charge current vs. temperature distribution” representing the relationship between the charge current and temperature of the battery 40 of the selected vehicle 10-3 as usage history information similar to the usage history information of the vehicle 10-1. The selection unit 140 selects information of one factor affecting the deterioration of the battery 40 from the usage history information of the vehicle 10-3.

In FIG. 9, the selection unit 140 selects distribution information “SOC vs. temperature distribution” representing the relationship between the SOC (charge rate) and temperature of the battery 40 of the selected vehicle 10-4 as usage history information similar to the usage history information of the vehicle 10-1. The selection unit 140 selects distribution information “discharge current vs. temperature distribution” representing the relationship between the discharge current and temperature of the battery 40 of the selected vehicle 10-4 as usage history information similar to the usage history information of the vehicle 10-1. The selection unit 140 selects information of two factors affecting the deterioration of the battery 40 from the usage history information of the vehicle 10-4.

The selection unit 140 generates data for estimation of the battery capacity of the battery 40 of the target vehicle on the basis of the selected transition information and usage history information. The method of generating data for estimation is not limited to a specific generation method.

For example, the selection unit 140 generates data for estimation including information indicating the weight coefficient and the battery capacity of each of the selected vehicles 10. In FIG. 9, since information of one factor affecting the deterioration of the battery 40 is selected from the usage history information of the vehicle 10-3, the selection unit 140 sets the weight coefficient of the vehicle 10-3 to 1 according to the number of selected factors. Since information of two factors affecting the deterioration of the battery 40 are selected from the usage history information of the vehicle 10-4, the selection unit 140 sets the weight coefficient of the vehicle 10-4 to 2 according to the number of selected factors.

In FIGS. 8 and 9, the selection unit 140 generates data for estimation of the battery capacity of the battery 40 of the target vehicle on the basis of the transition information and usage history information of the battery 40 of the vehicle 10-3 and the transition information and usage history information of the battery 40 of the vehicle 10-4. The data for estimation includes the weight coefficient “1” of the vehicle 10-3, the weight coefficient “2” of the vehicle 10-4, and information representing the battery capacity “70 (30%)” of the vehicle 10-3 and information representing the battery capacity “90 (10%)” of the vehicle 10-4 at the same travel distance of “L2” as the travel distance of the vehicle 10-1.

The selection unit 140 transmits the data for estimation of the battery capacity of the battery 40 of the vehicle 10-1 to the vehicle 10-1 via the communication device 50.

Next, estimation of the battery capacity will be described.

The battery/VCU control unit in the control unit 36 of the vehicle 10-1 derives the battery capacity of the battery 40 on the basis of a result of dividing the amount of change (ΔAh) of the current integration value of the battery 40 by the amount of change (ΔSOC) of the charge rate of the battery 40. The battery/VCU control unit corrects the derived battery capacity (=ΔAh/ΔSOC) with the data for estimation. For example, the battery/VCU control unit corrects the battery capacity by a weighting process such as that of alpha blending.

(When Estimating Battery Capacity on the Basis of Data for Estimation Generated from Selected Transition Information)

The battery/VCU control unit estimates the battery capacity of the battery 40 of the vehicle on the basis of the transition information. The VCU control unit estimates the battery capacity of the battery 40 of the vehicle on the basis of one of the estimated values of the battery capacities of the plurality of vehicles 10 in the transition information. The battery/VCU control unit updates the estimated value of the battery capacity of the battery 40 of the vehicle to the battery capacity “70” of the vehicle 10-3. The battery/VCU control unit may also update the estimated value of the battery capacity of the battery 40 of the vehicle to the battery capacity “90” of the vehicle 10-4. The battery/VCU control unit updates the estimated value “80” of the battery capacity to the corrected estimated value of the battery capacity in a program.

The battery/VCU control unit may also estimate the battery capacity of the battery 40 of the vehicle on the basis of an average value of the battery capacities of the plurality of vehicles 10 in the transition information. The battery/VCU control unit estimates the battery capacity of the battery 40 of the vehicle to be 80 (=an average value of the battery capacity “70” of the vehicle 10-3 and the battery capacity “90” of the vehicle 10-4). The battery/VCU control unit may overwrite the estimated value “80” of the battery capacity with the corrected battery capacity “80” in the program. (When estimating battery capacity on the basis of data for estimation generated from selected transition information and usage history information)

The battery/VCU control unit estimates the battery capacity of the battery 40 of the vehicle on the basis of the transition information and the usage history information. For example, the battery/VCU control unit estimates the battery capacity of the battery 40 of the vehicle on the basis of the weight coefficient generated from the usage history information and the battery capacity of each vehicle 10 in the transition information. The battery/VCU control unit estimates the battery capacity of the battery 40 of the vehicle to be 83 (=((weight coefficient “1” of vehicle 10-3)×(battery capacity “70” of vehicle 10-3)+(weight coefficient “2” of vehicle 10-4)×(battery capacity “90” of vehicle 10-4))/the sum of weight coefficients (1+2)). In this case, the battery/VCU control unit updates the estimated value of the battery capacity from the battery capacity before correction “80” to the battery capacity after correction “83” in the program.

Next, an exemplary operation of the target vehicle will be described.

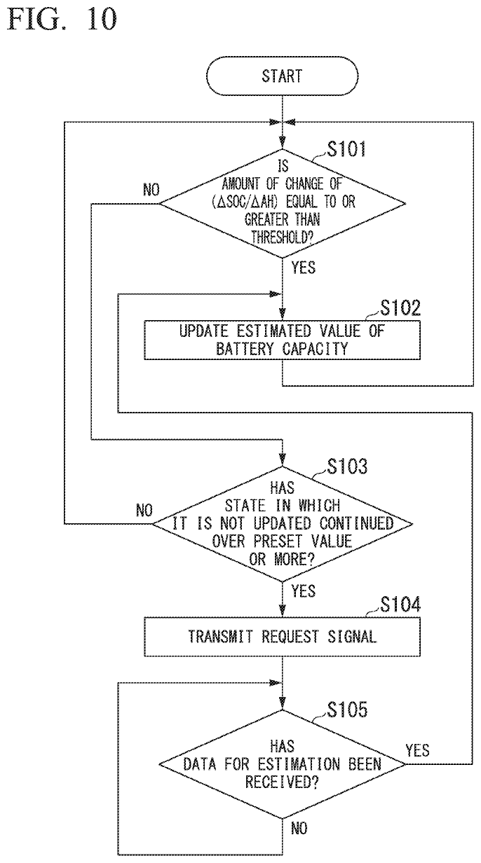

FIG. 10 is a sequence diagram showing an exemplary operation of the target vehicle. The battery/VCU control unit determines whether the amount of change of (ΔSOC/ΔAh) is equal to or greater than a threshold (step S101). When the amount of change of (ΔSOC/ΔAh) is equal to or greater than the threshold (step S101: YES), the battery/VCU control unit updates the estimated value of the battery capacity (step S102). The battery/VCU control unit returns the process to step S101.

When the amount of change of (ΔSOC/ΔAh) is less than the threshold (step S101: NO), the battery/VCU control unit determines whether or not the state in which the estimated value of the battery capacity is not updated has continued over a preset value or more (step S103). When the state in which the estimated value of the battery capacity is not updated has continued over less than the preset value (step S103: NO), the battery/VCU control unit returns the process to step S101. When the state in which the estimated value of the battery capacity is not updated has continued over the preset value or more (step S103: YES), the battery/VCU control unit transmits a request signal to the center server 100 via the communication device 50 (step S104).

The battery/VCU control unit determines whether the communication device 50 has received data for estimation (step S105). When the communication device 50 has not received data for estimation (step S105: NO), the battery/VCU control unit repeatedly executes step S105 for a predetermined period. When the communication device 50 has received data for estimation (step S105: YES), the battery/VCU control unit returns the process to step S102.

Next, an exemplary operation of the capacity estimation system 1 will be described.

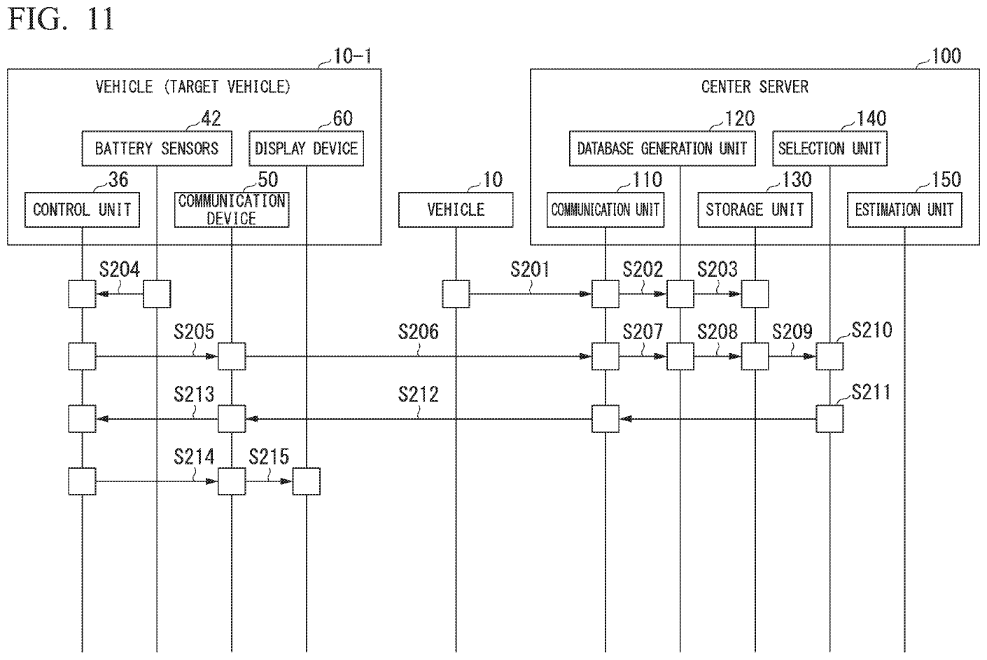

FIG. 11 is a sequence diagram showing an exemplary operation of the capacity estimation system 1. The communication unit 110 acquires transition information and usage history information of the battery 40 for each vehicle 10 (step S201). The database generation unit 120 generates a transition information database for the batteries 40 of vehicles 10 and a usage history information database for the batteries 40 of vehicles 10 (step S202). The database generation unit 120 records the transition information database and the usage history information database in the storage unit 130 (step S203).

The battery sensors 42 output information representing the current value, the voltage value, and the temperature of the battery 40 to the control unit 36 (step S204). The control unit 36 outputs the transition information and usage history information of the battery 40 to the communication device 50. The control unit 36 outputs a request signal to the communication device 50 when a state in which the battery capacity is not updated has continued over a preset value or more (step S205). The communication device 50 transmits the transition information and usage history information of the battery 40, the request signal, and the vehicle number of the vehicle to the center server 100 (step S206).

The communication unit 110 outputs the transition information and usage history information of the battery 40 of the target vehicle, the request signal, and the vehicle number of the target vehicle to the database generation unit 120 (step S207). The database generation unit 120 records the transition information of the battery 40 of the target vehicle and the vehicle number of the target vehicle in the transition information database for the batteries 40 of vehicles 10. The database generation unit 120 records the usage history information of the battery 40 of the target vehicle and the vehicle number of the target vehicle in the usage history information database for the batteries 40 of vehicles 10 (step S208).

Upon receiving the request signal, the selection unit 140 accesses the storage unit 130 and refers to the transition information database illustrated in FIG. 8. The selection unit 140 selects one or more vehicles 10 other than the target vehicle from the transition information database on the basis of the transition information acquired from the vehicle 10-1 which is the target vehicle. The selection unit 140 selects vehicles 10 that have traveled a travel distance longer than the travel distance of the target vehicle. The selection unit 140 may also select vehicles 10 in which batteries 40 whose elapsed usage times are longer than the elapsed usage time of the battery 40 of the target vehicle are mounted. The selection unit 140 selects transition information of the selected vehicles 10 (step S209).

Upon receiving the request signal, the selection unit 140 accesses the storage unit 130 and refers to the usage history information database illustrated in FIG. 9. The selection unit 140 selects usage history information similar to the usage history information of the target vehicle from the usage history information of each of the selected vehicles 10 (step S210).

The selection unit 140 generates data for estimation of the battery capacity of the battery 40 of the target vehicle on the basis of the selected estimation information and usage history information. The data for estimation may include, for example, information indicating the weight coefficient and the battery capacity of each of the selected vehicles 10 (step S211). The communication unit 110 transmits the data for estimation of the battery capacity of the battery 40 of the target vehicle to the communication device 50 of the target vehicle (step S212).

The communication device 50 outputs the data for estimation of the battery capacity to the control unit 36 (step S213). The control unit 36 estimates the battery capacity of the battery 40 of the vehicle on the basis of the data for estimation of the battery capacity. That is, the control unit 36 corrects the measurement result of the battery capacity of the battery 40 of the vehicle with the acquired data for estimation. The control unit 36 derives the charge rate of the battery 40 on the basis of the battery capacity of the battery 40 (step S214). The communication device 50 causes the display device 60 to display an image representing the charge rate of the battery 40 (step S215).

As described above, the capacity estimation system 1 of the first embodiment includes the center server 100 and a plurality of vehicles 10 including a target vehicle. The center server 100 includes the communication unit 110 (acquisition unit), the database generation unit 120, and the selection unit 140. The vehicle 10 includes the control unit 36. The communication unit 110 is configured to acquire, for each of the plurality of vehicles 10, transition information which is information indicating a transition of the battery capacity of the battery 40 of the vehicle 10 and usage history information which is information indicating a usage history of the battery 40. The database generation unit 120 is configured to generate a database including the transition information and the usage history information for each vehicle 10. The selection unit 140 is configured to select at least transition information among transition information and usage history information of a vehicle 10 which are similar to transition information and usage history information of the target vehicle among the plurality of vehicles 10. The control unit 36 is configured to estimate the battery capacity of the battery 40 of the target vehicle on the basis of the at least transition information selected by the selection unit 140.

Thereby, the capacity estimation system 1 of the first embodiment can improve the estimation accuracy of the battery capacity of the secondary battery.

When the battery capacity (the degree of deterioration) is derived on the basis of “ΔAh” and “ΔSOC” greater than a predetermined value, the estimation accuracy of the battery capacity is high. The center server 100 generates data for estimation of the battery capacity of the battery 40 of the target vehicle on the basis of a battery capacity of a battery 40 of a vehicle 10 for which the battery capacity has been derived on the basis of the great “ΔAh” and “ΔSOC” among vehicles 10 whose travel conditions or the like are similar to the travel condition or the like of the target vehicle. When the battery capacity (=ΔAh/ΔSOC) of the battery 40 of the vehicle is derived on the basis of “ΔAh” and “ΔSOC” of the battery 40 of the vehicle, the control unit 36 of the vehicle 10 corrects the battery capacity of the battery 40 of the vehicle using data for estimation that the center server 100 has generated on the basis of big data.

Thereby, the control unit 36 of the vehicle 10 can improve the estimation accuracy of the battery capacity of the battery 40 even in a travel condition in which the “ΔAh” of the battery 40 is small.

### Second Embodiment

A second embodiment is different from the first embodiment in that the center server 100 estimates the battery capacity. In the second embodiment, differences from the first embodiment will be described.

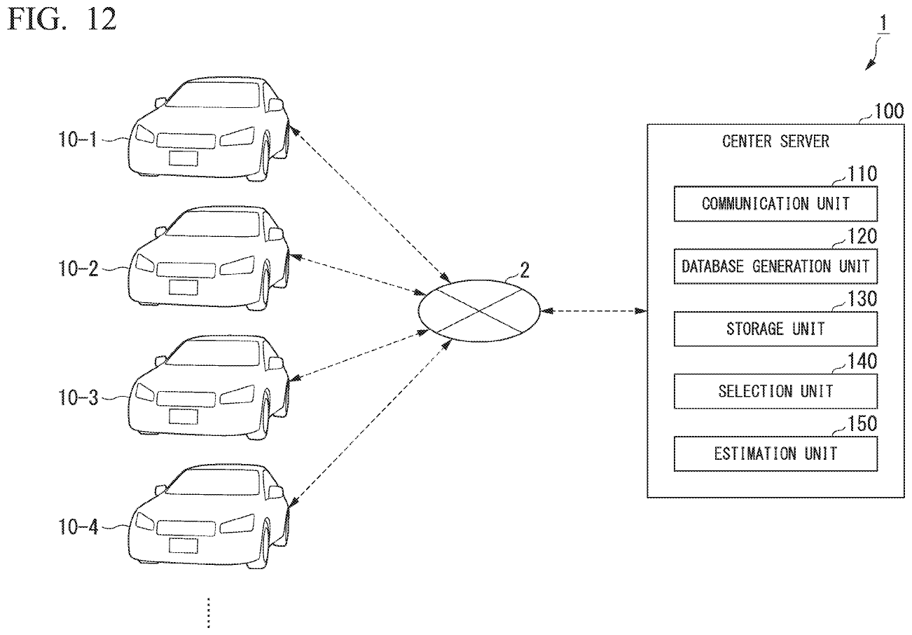

FIG. 12 is a diagram showing an exemplary configuration of the capacity estimation system 1. The center server 100 is a device that estimates the battery capacity (the degree of deterioration) of the battery 40 mounted in the vehicle 10, and is, for example, a server. Upon acquiring a request signal from the target vehicle, the center server 100 estimates the battery capacity of the battery 40 of the target vehicle on the basis of each database. The center server 100 transmits the estimated value of the battery capacity of the battery 40 to the target vehicle.

The center server 100 includes a communication unit 110 (acquisition unit), a database generation unit 120, a storage unit 130, a selection unit 140, and an estimation unit 150.

The estimation unit 150 acquires, from the selection unit 140, transition information selected by the selection unit 140. Similar to the battery/VCU control unit in the control unit 36 in the first embodiment, the estimation unit 150 estimates the battery capacity of the battery 40 of the vehicle on the basis of the transition information.

The estimation unit 150 may also acquire, from the selection unit 140, transition information and usage history information selected by the selection unit 140. Similar to the battery/VCU control unit in the control unit 36 in the first embodiment, the estimation unit 150 may estimate the battery capacity of the battery 40 of the vehicle on the basis of the transition information and the usage history information.

The estimation unit 150 transmits the estimated value of the battery capacity of the battery 40 to the target vehicle via the communication unit 110. The communication device 50 of the target vehicle receives the estimated value of the battery capacity of the battery 40. The display device 60 of the target vehicle displays an image representing the estimated value of the battery capacity of the battery 40.

Next, an exemplary operation of the capacity estimation system 1 will be described.

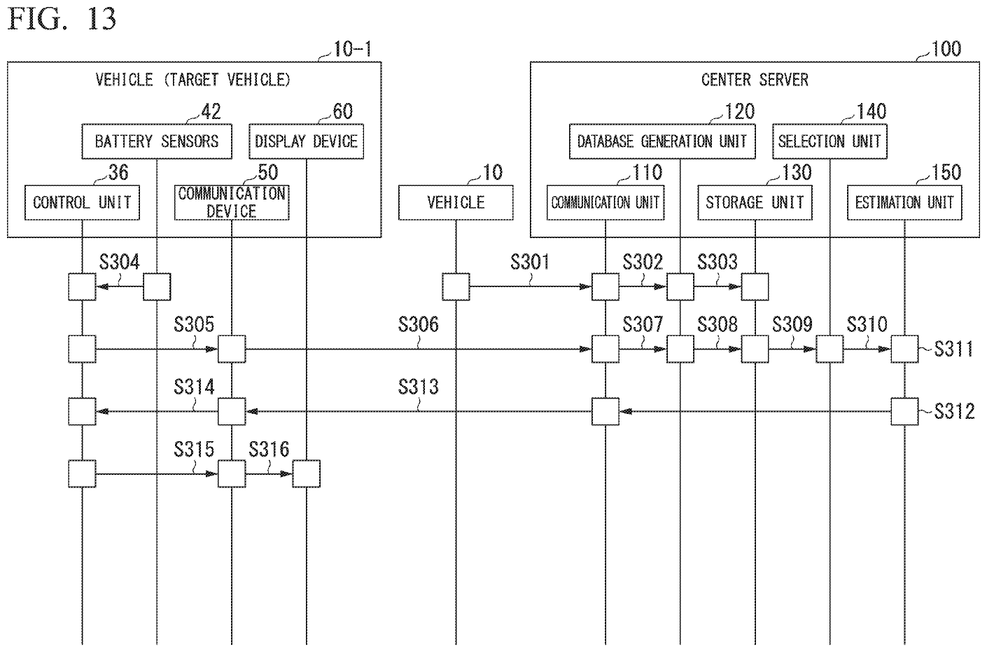

FIG. 13 is a sequence diagram showing an exemplary operation of the capacity estimation system 1. Processes of steps S301 to S310 are the same as those of steps S201 to S210 shown in FIG. 11.

The estimation unit 150 estimates the battery capacity of the battery 40 of the target vehicle on the basis of the selected estimation information and usage history information (step S311). The estimation unit 150 outputs the estimated value of the battery capacity of the battery 40 to the communication unit 110 (step S312). The communication unit 110 transmits the estimated value of the battery capacity of the battery 40 to the communication device 50 (step S313). The communication device 50 outputs the estimated value of the battery capacity of the battery 40 to the control unit 36 (step S314).

The control unit 36 derives the charge rate of the battery 40 on the basis of the estimated value of the battery capacity of the battery 40 (step S315). The communication device 50 causes the display device 60 to display an image representing the charge rate of the battery 40 (step S316).

As described above, the capacity estimation system 1 of the second embodiment includes the center server 100 (capacity estimation device) and a plurality of vehicles 10 including a target vehicle. The center server 100 includes the communication unit 110 (acquisition unit), the database generation unit 120, the selection unit 140, and the estimation unit 150. The communication unit 110 is configured to acquire, for each of the plurality of vehicles 10, transition information which is information indicating a transition of the battery capacity of the battery 40 of the vehicle 10 and usage history information which is information indicating a usage history of the battery 40. The database generation unit 120 is configured to generate a database including the transition information and the usage history information for each vehicle 10. The selection unit 140 is configured to select at least transition information among transition information and usage history information of a vehicle 10 which are similar to transition information and usage history information of the target vehicle among the plurality of vehicles 10. The estimation unit 150 is configured to estimate the battery capacity of the battery 40 of the target vehicle on the basis of the at least transition information selected by the selection unit 140.

Thereby, the capacity estimation system 1 of the second embodiment can improve the estimation accuracy of the battery capacity of the secondary battery.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A capacity estimation system comprising:
an acquisition unit configured to acquire, for each of a plurality of vehicles, transition information which is information indicating a transition of a battery capacity of a secondary battery of the vehicle and usage history information which is information indicating a usage history of the secondary battery;
a database generation unit configured to generate a database including the transition information and the usage history information for each of the plurality of vehicles;
a selection unit configured to select at least transition information among transition information and usage history information of a vehicle which are similar to transition information and usage history information of a target vehicle among the plurality of vehicles; and
an estimation unit configured to estimate a battery capacity of a secondary battery of the target vehicle on the basis of the at least transition information selected by the selection unit.

2. The capacity estimation system according to claim 1, wherein the acquisition unit, the database generation unit, and the selection unit are realized by a vehicle exterior device, and
at least part of the estimation unit is realized by a device mounted in the target vehicle.

3. The capacity estimation system according to claim 2, wherein the device mounted in the target vehicle is configured to transmit a request signal to the selection unit when a state in which an estimated value of the battery capacity of the secondary battery is not updated has continued over a reference or more, and
the selection unit is configured to transmit data for estimation of the battery capacity of the secondary battery in response to the request signal from the target vehicle.

4. The capacity estimation system according to claim 1, wherein the selection unit is configured to select at least transition information among transition information and usage history information of a vehicle in which a secondary battery whose elapsed usage time is longer than an elapsed usage time of the secondary battery of the target vehicle is mounted or a vehicle that has traveled a travel distance longer than a travel distance of the target vehicle.

5. The capacity estimation system according to claim 1, wherein the usage history of the secondary battery is a history of at least one of a charge rate, a current value, a voltage value, and a temperature of the secondary battery.

6. A capacity estimation method comprising:
acquiring, by one or more computers, for each of a plurality of vehicles, transition information which is information indicating a transition of a battery capacity of a secondary battery of the vehicle and usage history information which is information indicating a usage history of the secondary battery;
generating, by the one or more computers, a database including the transition information and the usage history information for each of the plurality of vehicles;
selecting, by the one or more computers, at least transition information among transition information and usage history information of a vehicle which are similar to transition information and usage history information of a target vehicle among the plurality of vehicles; and
estimating, by the one or more computers, a battery capacity of a secondary battery of the target vehicle on the basis of the selected at least transition information.

7. A computer readable non-transitory storage medium storing a program for causing one or more computers to execute:
acquiring, for each of a plurality of vehicles, transition information which is information indicating a transition of a battery capacity of a secondary battery of the vehicle and usage history information which is information indicating a usage history of the secondary battery;
generating a database including the transition information and the usage history information for each of the plurality of vehicles;
selecting at least transition information among transition information and usage history information of a vehicle which are similar to transition information and usage history information of a target vehicle among the plurality of vehicles; and
estimating a battery capacity of a secondary battery of the target vehicle on the basis of the selected at least transition information.
